(19) United States
(12) Patent Application Publication
(10) Pub. No.: US 2006/0253805 A1
(43) Pub. Date: Nov. 9, 2006

(54) Folder with ready access to and use of electronic articles

(76) Inventors: Giora Tamir, New City, NY (US); Alon Merimsky, Tel Aviv (IL)

Correspondence Address: KIRSCHSTEIN, OTTINGER, ISRAEL;& SCHIFFMILLER, P.C., 489 FIFTH AVENUE, NEW YORK, NY, 10017, US

(21) Appl. No.: 11/123,545

(22) Filed: May 7, 2005

(51) Int. Cl. G06F 3/00; G06F 9/00

(52) U.S. Cl. 715/864

(57) ABSTRACT

An electronic processor is mounted on a folder for use whether the folder is open or closed. The processor is received in a window opening in one working position and is moved automatically to another working position upon user actuation.

### BACKGROUND OF THE INVENTION

1. Field of the Invention

The present invention generally relates to folders with attached electronic articles and, more particularly, to facilitating access to, and use of, the electronic articles.

2. Description of the Related Art

Electronic processors, such as calculators, organizers, palm top computers, clocks, voice recorders, telephones, music players, cameras and like battery-operated electronic articles, have been miniaturized in recent years and become a desirable accessory for daily use. It is known, for example, from U.S. Pat. No. 5,232,301 to affix an electronic calculator to an outside edge of a front cover of a notebook binder so that the calculator can be operated whether the binder is open or closed. Although generally satisfactory for its intended use, it is cumbersome to manually swing the calculator about the outside edge of the front cover of the binder and to manually position the calculator against the front cover. Even so, the calculator always lays flat against the front cover which is not the most convenient position for ready access to the keypad thereon, or to ready viewing of the display thereon.

### SUMMARY OF THE INVENTION

### OBJECTS OF THE INVENTION

Accordingly, it is a general object of this invention to make an electronic processor readily available for use on the inside or outside of a folder, either in conjunction with, or independently of, any information contained within the folder.

More particularly, it is an object of the present invention to enable a user to select whether to operate the processor with the folder open or closed.

Still another object of the present invention is to enable an automatic controlled movement of the processor from one working position inside the folder to another working position outside the folder.

It is yet another object of the present invention to automatically position the processor to a raised, tilted position convenient for data entry and display viewing.

A still further object of the present invention is to simplify battery replacement in such processors mounted on folders.

### FEATURES OF THE INVENTION

In keeping with the above objects and others which will become apparent hereinafter, one feature of the present invention resides, briefly stated, in an assembly comprising a panel and an electronic processor mounted thereon. Advantageously, the panel is a planar front cover of a folder having a planar rear cover. When the covers are unfolded so that they are co-planar, the folder is in an open position. When the covers are folded so that they overlie each other, the folder is in a closed position. Advantageously, the folder holds work materials, such as a writing pad, writing utensils, electronic media and documents, and preferably includes pockets for storage of such materials. The folder can be a notebook binder having openable rings for receipt of apertured papers.

As noted previously, the electronic processor can be a calculator, organizer, computer, clock, voice recorder, telephone, music player, camera and like battery-operated electronic article having a working surface at which the processor is manually operated. For example, in the case of a calculator, a keyboard for manual data entry and a display screen for visually displaying information are located at the working surface of the calculator. The processor is mounted on the panel for movement between a first working position at which the working surface is manually accessible at one of the major surfaces of the panel, e.g., the interior surface of the front cover when the folder is in the open position, and a second working position at which the working surface is manually accessible at another major surface of the panel, e.g., the exterior surface of the front cover when the folder is in the closed position.

In accordance with one feature of this invention, the panel has a window opening extending between the major surfaces of the panel within its periphery. The processor is received in the window opening in one of the working positions, and is automatically moved out of the window opening to the other of the working positions upon manual release of a latch that normally holds the processor in the window opening. No longer is it necessary, as taught by the prior art, to swing the electronic processor in a cumbersome manner about an outside edge of the front cover. Instead, all movement of the processor occurs inside the periphery of the panel.

More specifically, a frame bounds the window opening, and a casing is pivotably mounted on the frame. The processor is mounted on the casing for joint movement therewith. A casing spring is operative for constantly urging the casing and the processor mounted thereon toward the other working position. A releasable casing latch is operative for latching the casing in the first working position, and for selectively releasing the casing to move automatically to the second working position by action of the casing spring. A damper element is advantageously operatively connected to the casing spring to enable the released casing to automatically move in a controlled damped manner.

As described so far, the working surface of the processor lies in a plane flush with one of the major surfaces of the panel in the first working position. Access to the working surface is through the window opening. In the second working position, the working surface lies in a plane parallel to and above the other major surface of the panel.

In further accordance with this invention, it is preferable if the working surface lies in a plane inclined at an acute angle relative to either major surface of the panel. Tilting of the processor is accomplished by mounting a protective lid on the processor for pivoting movement between a covering position in which the lid covers the display screen of the processor, and a support position in which the lid supports the processor in a tilted position. A lid spring is provided for constantly urging the lid toward the support position. A releasable lid latch is operative for latching the lid in the covering position, and for selectively releasing the lid to move automatically to the support position by action of the lid spring. The tilted processor facilitates data entry at the keyboard, as well as viewing of the display screen, by the user.

The novel features which are considered as characteristic of the invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a perspective view of a folder in the closed position prior to deployment of an electronic processor exteriorly of the folder;

FIG. 2 is a broken-away, perspective view of the folder after deployment of the processor of FIG. 1;

FIG. 3 is a view analogous to FIG. 2 prior to tilting of the processor;

FIG. 4 is a view analogous to FIG. 2 after the processor has been tilted for use exteriorly of the folder;

FIG. 5 is a perspective view of the folder of FIG. 1 in the open position prior to tilting of the processor;

FIG. 6 is a broken-away, perspective view of the folder of FIG. 5 after the processor has been tilted for use interiorly of the folder;

FIG. 7 is an enlarged, perspective view of the tilted processor of FIG. 6 depicting battery replacement;

FIG. 8 is a sectional view taken on line 8-8 of FIG. 1;

FIG. 9 is a sectional view taken on line 9-9 of FIG. 1;

FIG. 10 is a sectional view taken on line 10-10 of FIG. 5; and

FIG. 11 is a sectional view taken on line 11-11 of FIG. 4.

### DETAILED DESCRIPTION OF THE PREFERRED EMBODIMENTS

Referring now to the drawings, reference numeral 10 generally identifies a folder shown in a closed position in FIG. 1 and in an open position in FIG. 5. The folder 10 has a planar front cover 12 and a planar rear cover 14. The covers 12, 14 overlie each other in the closed position and do not overlap each other in the open position. As best seen in FIG. 5, the folder has a rear pocket in the rear cover for receiving a writing pad 16, a loop 18 for receiving a writing utensil 20, and a front pocket 22 for receiving electronic media such as a CD 24. Other pockets for holding other documents or work accessories can be provided.

As illustrated, the folder is an executive-type portfolio in which the covers are interconnected by an integral spine 26. Each cover comprises an inner shape-retaining material, such as a plastic or cardboard panel, and an outer flexible material, such as leather or vinyl. The outer material of the covers and the spine are preferably of one-piece construction. Other than a flexible spine, the folder could be a notebook binder having rings which open to receive apertured looseleaf sheets, and which snap closed to hold the sheets in the rings.

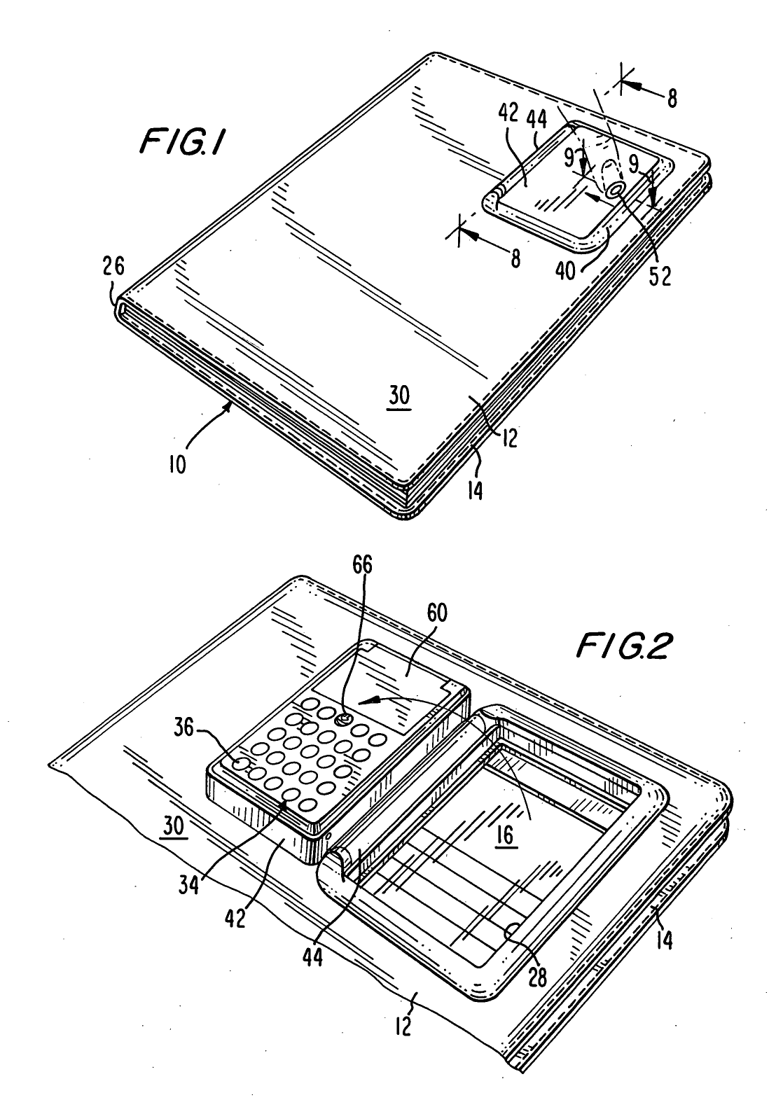

In accordance with this invention, one of the covers, for example, the front cover 12 (also sometimes referred to as a panel) has a window opening 28 extending between an exterior, major, planar surface 30 (see FIG. 2) of the cover 12 and an interior, major, opposite planar surface 32 (see FIG. 5). The front cover 12 has a periphery (as illustrated, a rectangular periphery), and the window opening 28 is located within the periphery. As shown, the window opening is located adjacent the upper right-hand corner of the front cover 12, but other positions within the periphery of the front cover are also contemplated.

An electronic processor 34 is mounted on the cover 12 for movement between working positions, as detailed below. In one of the working positions, as depicted in FIG. 5, the processor 34 is located in the window opening 28. As illustrated, the processor 34 is an electronic calculator having a keyboard 36 (see FIG. 7) for manual data entry, and a display screen 38 for visually displaying information. The upper surface of the calculator is referred to herein as the working surface at which the processor is operated, that is, the keyboard is accessed at the working surface, and the display screen is viewed at the working surface. It is the working surface, according to this invention, which is to be manually accessible to a user in each of the working positions, so that the processor is available for use at the interior surface 32 or at the exterior surface 30 of the cover 12, either in conjunction with, or independently of, any of the information, tools or documents contained within the folder. As previously noted, instead of a calculator, the processor can be any battery-operated device, such as an organizer, computer, clock, voice recorder, telephone,-music player, camera and like devices.

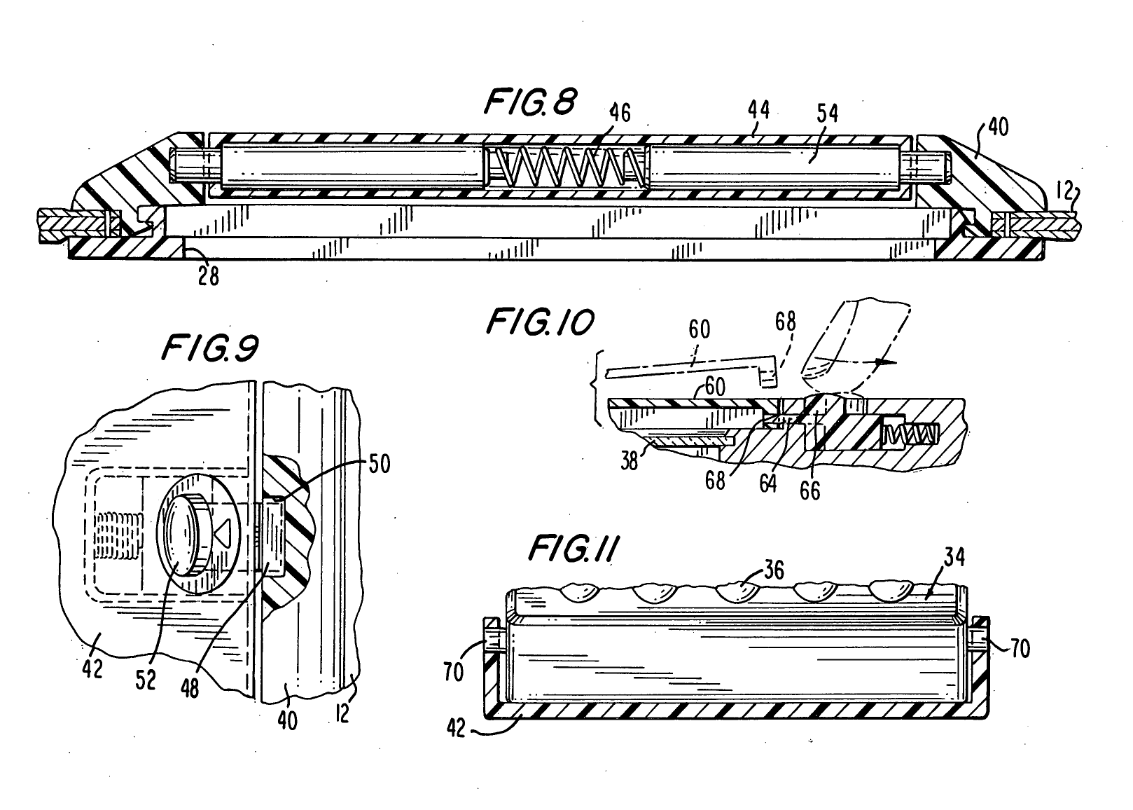

A frame 40 borders the window opening 28. A casing 42 is mounted on the frame 40 for pivoting movement. The processor 34 is mounted on the casing 42 for joint movement therewith between the working positions. As best seen in FIG. 8, the casing 42 is pivotably connected at a hinge 44 to the frame. A casing spring 46 within the hinge is tensioned for constantly urging the casing and the processor mounted thereon away from the window opening. A releasable spring-biased casing latch 48, as best seen in FIG. 9, engages a latching recess 50 in the frame 40 for latching the casing in the window opening. A button 52 is manually actuated to retract the casing latch 48 from engagement with the latching recess, thereby releasing the casing to move automatically away from the window opening by action of the casing spring 46.

A damper drum 54 of the type described in U.S. Pat. No. 6,178,085 is operatively connected to the casing spring 46 and is located in a cylindrical bore as is the casing spring 46. A damping grease of high viscosity falls the bore around the drum to facilitate a controlled and damped pivoting movement of the casing away from the window opening upon release of the casing latch. This controlled, slow movement to the position shown in FIG. 2 prevents the casing from suddenly slamming against the exterior surface 30 to prevent damage to the processor 34 mounted on the casing.

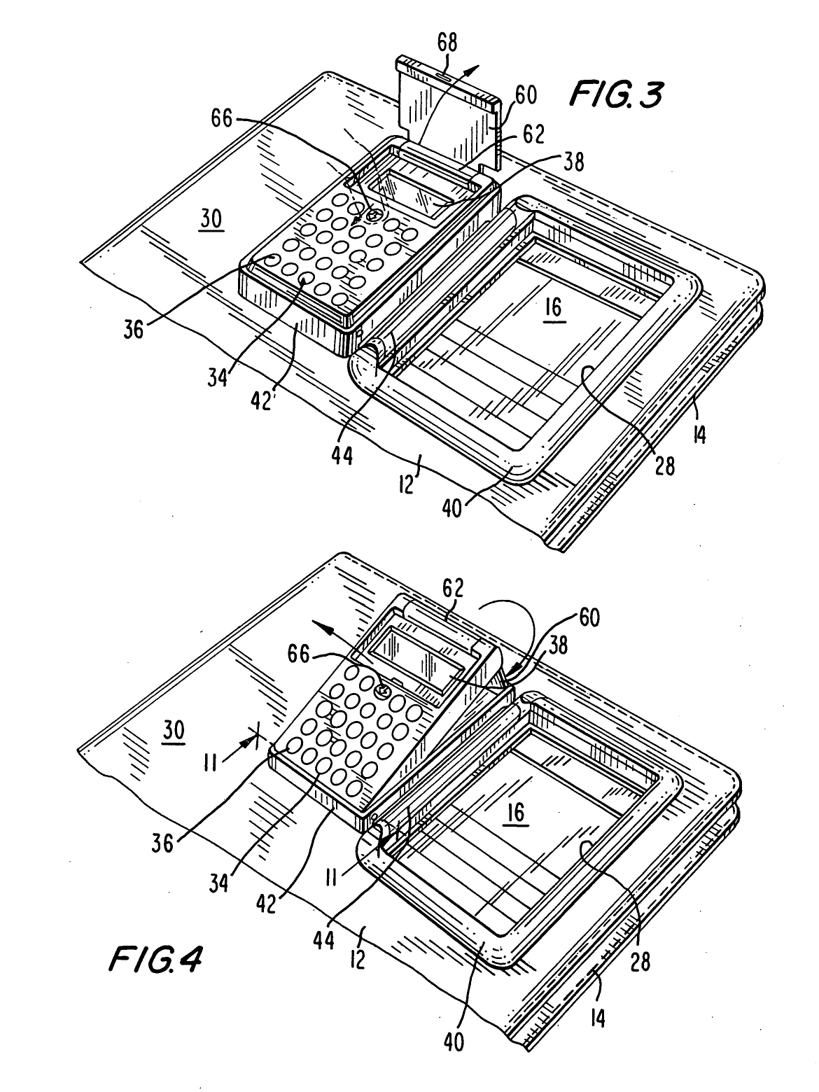

Although the working surface of the processor is exposed and ready for data entry in FIG. 2, the working surface is parallel to the exterior surface 30 of the cover 12. More convenient access to the working surface is obtained by tilting the processor so that its working surface is at an acute angle relative to the exterior surface 30. Hence, this invention further proposes a lid 60 mounted on the processor for pivoting movement between a covering position (see FIG. 2) in which the lid 60 protectively covers the display screen 38, and a support position (FIG. 4) in which the lid 60 supports the processor in a tilted position. To initiate this pivoting action of the lid, the lid 60 is connected to the processor by a hinge 62 which is identical to the aforementioned hinge 44 in that the hinge 62 has a torsion lid spring and a damper drum within a cylindrical bore of the hinge 62. As best seen in FIG. 10, a releasable lid latch 64 connected to a manually actuated button 66 engages a latching recess 68 formed in the lid for latching the lid in the covering position. When the button 66 is actuated, the latch 64 is unlatched from the recess 68, thereby releasing the lid to move automatically (see FIG. 3) over an obtuse angle around the processor due to the action of the lid spring to the support position in which the lid supports the processor from underneath the same. As shown in FIG. 11, a lower end of the processor has stub shafts 70 journaled in co-linear openings in the casing 42 to permit the upper end of the processor to tilt relative to the casing.

As described so far in connection with FIGS. 1-4, a user actuates the button 52 to release the casing 42 for movement and enable the working surface of the processor 34 to be exposed above and parallel to the exterior surface 30 of the front cover 12. In a separate actuation of the button 66, the lid 60 is released to expose the display screen 38 and tilt the working surface of the processor relative to the exterior surface 30 of the front cover. The folder remains closed while the user operates the processor in this working position. To return the processor to its initial position, the lid 60 is returned to its covering position, and then the processor and the casing are returned to their position in the window opening.

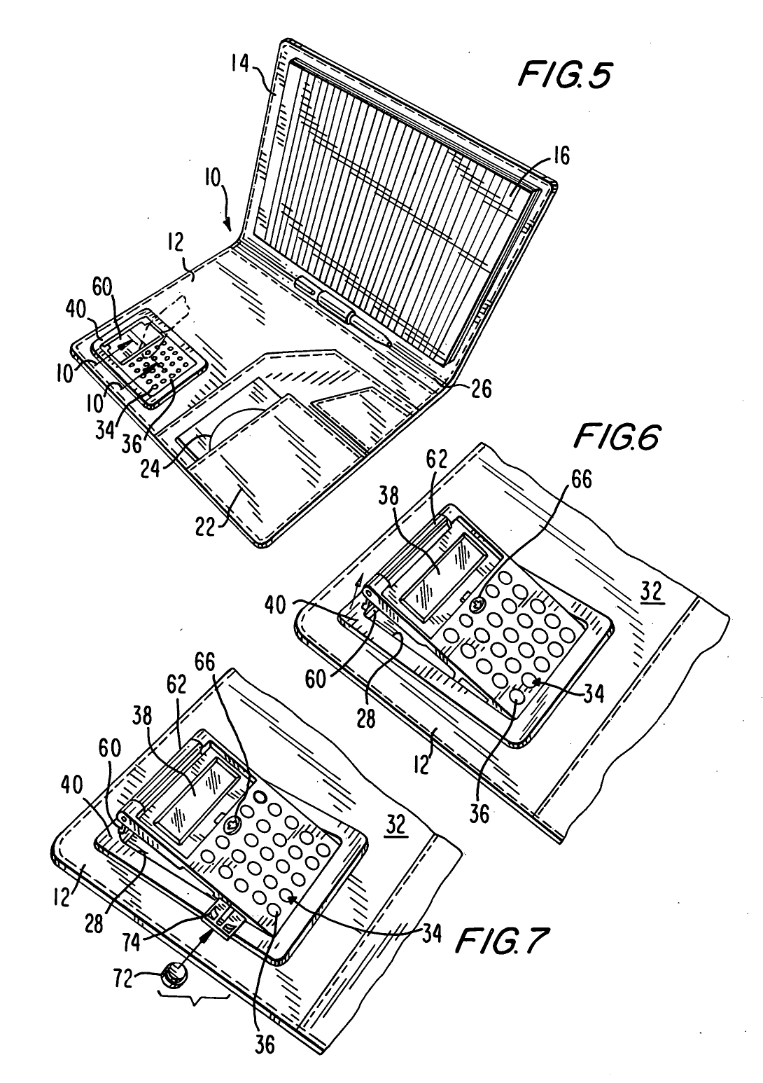

As shown in FIGS. 5-7, the processor can also be operated when the folder is open. Thus, in FIG. 5, the working surface of the processor is flush with the interior surface 32 of the front cover and is exposed through the window opening 28 for data entry. Actuation of the button 66, as before, releases the lid 60 to expose the display screen and tilt the working surface of the processor relative to the interior surface 32, as seen in FIG. 6. The user operates the processor in this working position. To return the processor to its initial position, the lid 60 is returned to its covering position.

Replacement of a battery 72 in a side drawer 74 is performed when the processor is in the tilted position, as been seen in FIG. 7. It is not necessary to remove the processor from the casing 42 to effect battery replacement.

Other variants of this invention include such features as not requiring the processor to be mounted on a folder. For example, the processor need only be mounted in a window opening on a single panel, such as a clipboard, in which case, the processor could be operated at both sides of the clipboard. Also, instead of requiring the separate actuations of two buttons 52, 66 in order to position the processor in the tilted position, this invention also contemplates that a single button be actuated to achieve all the movements through the use of a linkage.

Nor is this invention to be limited to the use of a single processor or a single window opening. For example, two processors and two window openings could be provided. It is also contemplated that the movement of a first processor out of one window opening could be followed by the movement of a second processor into the same opening vacated by the first processor.

It will be understood that each of the elements described above, or two or more together, also may find a useful application in other types of constructions differing from the types described above.

While the invention has been illustrated and described as embodied in a folder with ready access to and use of electronic articles, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention and, therefore, such adaptations should and are intended to be comprehended within the meaning and range of equivalence of the following claims.

What is claimed as new and desired to be protected by Letters Patent is set forth in the appended claims.

We claim:

1. An assembly for facilitating access to, and use of, electronic articles, the assembly comprising:
a) a panel having opposite, planar, major surfaces, a periphery, and a window opening extending between the major surfaces within the periphery of the panel; and
b) an electronic processor having a working surface at which the processor is operated, the processor being mounted on the panel for movement between a first working position at which the working surface is manually accessible at one of the major surfaces, and a second working position at which the working surface is manually accessible at the other of the major surfaces, the processor being received in the window opening in one of the working positions.

2. The assembly of claim 2, wherein the panel is a front cover of a folder having a rear cover, wherein the covers are unfolded to an open position in the first working position of the processor, and wherein the covers are folded to a closed position in the second working position of the processor.

3. The assembly of claim 1, wherein the processor is an electronic calculator having a keypad for manually entering data and a display for visually displaying information, and wherein the keypad and the display are located, and accessible, at the working surface.

4. The assembly of claim 1, wherein the processor is mounted on the panel by a frame bounding the window opening, and a casing mounted on the frame for pivoting movement between the working positions; and wherein the processor is mounted on the casing for joint pivoting movement therewith.

5. The assembly of claim 1, wherein the working surface of the processor lies in a plane which is co-planar with the one major surface in the first working position, and wherein the working surface of the processor lies in parallelism with and above the other major surface in the second working position.

6. The assembly of claim 4, wherein the casing is received in the window opening in the one working position; a casing spring for constantly urging the casing and the processor mounted thereon toward the other of the working positions; and a releasable casing latch for latching the casing in the one working position, and for selectively releasing the casing to move to the other working position by action of the casing spring.

7. The assembly of claim 6, and a damper element operatively connected to the casing spring, for enabling movement of the casing released by the casing latch in a controlled damped manner.

8. The assembly of claim 4, wherein the processor has a display for visually displaying information; a protective lid mounted on the processor for pivoting movement between a covering position in which the lid covers the display, and a support position in which the lid supports the processor; a lid spring for constantly urging the lid toward the support position; and a releasable lid latch for latching the lid in the covering position, and for selectively releasing the lid to move to the support position by action of the lid spring.

9. The assembly of claim 8, wherein the processor is also mounted on the casing for pivoting movement relative thereto between a lowered position when the lid is in the covering position, and a raised position when the lid is in the support position.

10. The assembly of claim 9, wherein the working surface of the processor in the raised position lies in a plane that is inclined at an acute angle relative to the respective major surface of the panel in each of the working positions.

11. The assembly of claim 10, wherein the processor is powered by a battery which is replaceable in the raised position of the processor.

12. An assembly for facilitating access to, and use of, electronic articles, the assembly comprising:
a) a folder having front and rear covers movable between open and closed positions of the folder, one of the covers having opposite, planar, major, interior and exterior surfaces, a periphery, and a window opening extending between the interior and exterior surfaces within the periphery of the one cover;
b) an electronic processor having a working surface at which the processor is manually operated; and
c) means for mounting the processor on the one cover for movement between a first working position at which the working surface is manually accessible at the interior surface, and a second working position at which the working surface is manually accessible at the exterior surface, the processor being received in the window opening in one of the working positions.

13. The assembly of claim 12, wherein the mounting means includes a frame bounding the window opening, and a casing mounted on the frame for pivoting movement between the working positions; and wherein the processor is mounted on the casing for joint pivoting movement therewith.

14. The assembly of claim 12, wherein the working surface of the processor lies in a plane which is co-planar with the interior surface in the first working position, and wherein the working surface of the processor lies in parallelism with and above the exterior surface in the second working position.

15. The assembly of claim 13, wherein the casing is received in the window opening in the first working position; and wherein the mounting means includes a casing spring for constantly urging the casing and the processor mounted thereon toward the second working position, and a releasable casing latch for latching the casing in the first working position, and for selectively releasing the casing to move to the second working position by action of the casing spring.

16. The assembly of claim 15, wherein the mounting means includes a damper element operatively connected to the casing spring, for enabling movement of the casing released by the casing latch in a controlled damped manner.

17. The assembly of claim 15, wherein the processor has a display for visually displaying information; a protective lid mounted on the processor for pivoting movement between a covering position in which the lid covers the display, and a support position in which the lid supports the processor; a lid spring for constantly urging the lid toward the support position; and a releasable lid latch for latching the lid in the covering position, and for selectively releasing the lid to move to the support position by action of the lid spring.

18. The assembly of claim 17, wherein the processor is also mounted on the casing for pivoting movement relative thereto between a lowered position when the lid is in the covering position, and a raised position when the lid is in the support position.

19. The assembly of claim 18, wherein the working surface of the processor in the raised position lies in a plane that is inclined at an acute angle relative to the respective interior and exterior surfaces int the first and second working positions, respectively.

20. The assembly of claim 18, wherein the processor is powered by a battery which is replaceable in the raised position of the processor.
